(19) United States
(12) Patent Application Publication
(10) Pub. No.: US 2014/0308575 A1
(43) Pub. Date: Oct. 16, 2014

(54) RECHARGEABLE BATTERY

(71) Applicant: Samsung SDI Co., Ltd., Yongin-si (KR)

(72) Inventors: Yong-Sam Kim, Yongin-si (KR); Jang-Hyun Song, Yongin-si (KR); Jong-Woo Nam, Yongin-si (KR)

(73) Assignee: Samsung SDI Co., Ltd., Yongin-si (KR)

(21) Appl. No.: 13/962,791

(22) Filed: Aug. 8, 2013

(30) Foreign Application Priority Data
Apr. 16, 2013 (KR) 10-2013-0041733

(51) Int. Cl. H01M 2/22

(52) U.S. Cl. CPC H01M 2/22
USPC 429/179

(57) ABSTRACT

A rechargeable battery is provided including an electrode assembly including a positive electrode and a negative electrode; a case accommodating the electrode assembly; a cap plate coupled to the case; a first terminal and a second terminal electrically connected to the electrode assembly and protruding outside the cap plate; and a short-circuit member at the cap plate and contacting the first terminal by transformation to induce a short.

### CROSS-REFERENCE TO RELATED APPLICATION

This application claims priority to and the benefit of Korean Patent Application No. 10-2013-0041733 filed in the Korean Intellectual Property Office on Apr. 16, 2013, the entire contents of which are incorporated herein by reference.

### BACKGROUND

1. Field

The present invention relates to a rechargeable battery

2. Description of the Related Art

A rechargeable battery differs from a primary battery in that it can be repeatedly charged and discharged, while the latter only irreversibly converts chemical energy to electrical energy. A low-capacity rechargeable battery is used as a power supply for small electronic devices, such as cellular phones, notebook computers, and camcorders, while a high-capacity rechargeable battery is used as a power supply for driving motors in hybrid vehicles and the like.

A high-power rechargeable battery using a non-aqueous electrolyte with high energy density has been recently developed. For example, the high-power rechargeable battery is constructed with a plurality of rechargeable cells coupled to each other in series such that it can be used as a power supply for driving motors in electric vehicles requiring a high amount of power.

Furthermore, one high-capacity rechargeable battery is commonly formed with a plurality of rechargeable cells coupled to each other in series. The rechargeable battery may have a cylindrical shape or a prismatic shape. When the internal pressure of the rechargeable battery is increased, a chance of explosion increases. Some batteries include a structure to induce an external short to prevent an explosion, but to induce the external short, the number of related components is increased and an assembly process is complicated.

The above information disclosed in this Background section is only for enhancement of understanding of the background of the invention and therefore it may contain information that does not form the prior art that is already known in this country to a person of ordinary skill in the art.

### SUMMARY

Embodiments of the present invention provides a rechargeable battery with an improved assembly characteristic and improved safety.

A rechargeable battery according to the present invention includes: an electrode assembly including a positive electrode and a negative electrode; a case having a space receiving the electrode assembly; a cap plate coupled to the case; a first terminal and a second terminal electrically connected to the electrode assembly and protruding outside the cap plate; and a short-circuit member installed at the cap plate and contacting the first terminal by transformation to induce a short.

The first terminal may include an upper connection part separated from the short-circuit member and positioned on the short-circuit member, a current collecting connection part connected to the electrode assembly, and a middle connection part formed between the upper connection part and the current collecting connection part and bent from the upper connection part and the current collecting connection part.

The upper connection part and the current collecting connection part may be oriented substantially parallel to the cap plate, and a sealing member sealing between the first terminal and the cap plate may be formed at the first terminal to partially enclose the terminal.

The sealing member may be formed by insert injection, and the sealing member may include an upper sealing part mounted on the cap plate and a lower sealing part inserted and fixed to a terminal hole formed at the cap plate.

The lower sealing part may include a hole in which the middle connection part is inserted, and a groove connected to the hole and receiving a current collecting connection part may be formed at a lower surface of the lower sealing part.

A protrusion may be formed inside the terminal hole, a sealing groove receiving the protrusion may be formed at the circumference of the lower sealing part, the protrusion may be extended according to a circumference direction from an interior circumference of the terminal hole, and the sealing groove may be extended according to a circumference of the lower sealing part.

The current collecting connection part may be connected to the electrode assembly through a current collecting member, and a protrusion inserted into the current collecting member may be formed at the lower surface of the current collecting connection part.

The short-circuit member may include a supporting part separated from the upper connection part, installed to face the lower surface of the upper connection part, and fixed to the cap plate, and a connector positioned inside the supporting part and curved downward to convexly protrude.

The short-circuit member may be integrally formed with the cap plate and have a thinner thickness than other portions of the cap plate, and is convexly curved downward, and a connection member electrically connecting the second terminal to the cap plate may be formed between the second terminal and the cap plate.

The current collecting member may be coupled to the electrode assembly by welding, the cap plate may include a protrusion inserted into the current collecting member, and the second terminal may include a middle connection part integrally formed with the cap plate and protruding at the upper surface of the cap plate and an upper connection part bent from the middle connection part.

The second terminal may include a lower connection part fixed to the upper surface of the cap plate by welding, a middle connection part bent from the lower connection part to protrude upward, and an upper connection part bent from the middle connection part and oriented substantially parallel to the cap plate.

According to an exemplary embodiment of the present invention, the terminal may directly contact the short-circuit member such that the assembly characteristic may be improved, and the sealing member is installed at the cap plate and the terminal by insert molding such that the process may be simplified.

### BRIEF DESCRIPTION OF THE DRAWINGS

FIG. 1 is a perspective view of a rechargeable battery according to a first exemplary embodiment of the present invention.

FIG. 2 is a cross-sectional view taken along the line II-II of FIG. 1.

FIG. 3 is a perspective view of a terminal according to the first exemplary embodiment of the present invention.

FIG. 4 is an exploded perspective view of a cap plate and a sealing member according to the first exemplary embodiment of the present invention.

FIG. 5 is a cross-sectional view of a terminal and a cap plate according to the first exemplary embodiment of the present invention.

FIG. 6 is a cross-sectional view of a rechargeable battery according to a second exemplary embodiment of the present invention.

FIG. 7 is a cut-away perspective view of a terminal and a cap plate according to the second exemplary embodiment of the present invention.

FIG. 8 is a cut-away perspective view of a terminal and a cap plate according to the second exemplary embodiment of the present invention.

FIG. 9 is a cut-away perspective view of a terminal and a cap plate according to a third exemplary embodiment of the present invention.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Like reference numerals designate like elements throughout the specification.

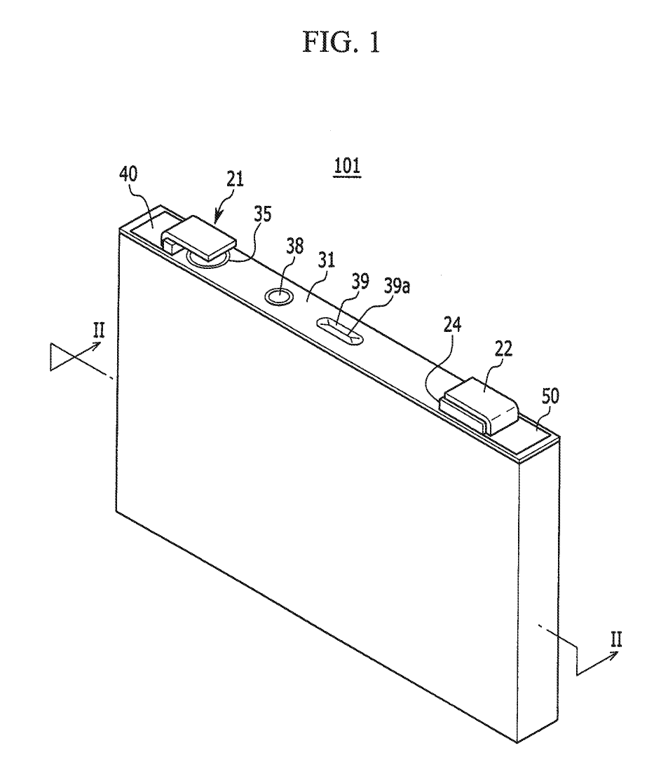

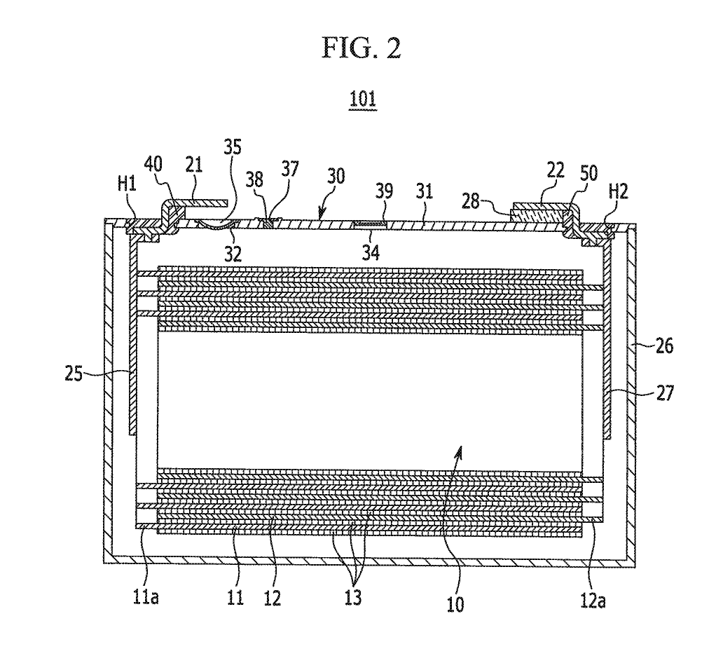

FIG. 1 is a perspective view of a rechargeable battery according to the first exemplary embodiment of the present invention, and FIG. 2 is a cross-sectional view taken along the line II-II of FIG. 1.

Referring to FIG. 1 and FIG. 2, a rechargeable battery 101 according to the first exemplary embodiment includes an electrode assembly 10 where a negative electrode (e.g., a first electrode) 11 and a positive electrode (e.g., a second electrode) 12 are wound with an insulating separator 13 therebetween, a case 26 mounting the electrode assembly 10 therein, and a cap assembly 30 coupled to an opening of the case 26.

The rechargeable battery 101 according to the first exemplary embodiment of the present invention is a lithium ion rechargeable battery which has an angular shape, and will be described as an example. However, the present invention is not limited thereto, and the present invention may be applied to batteries such as a lithium polymer battery, a cylindrical battery, and the like.

The positive electrode 11 and the negative electrode 12 include a coating region where an active material is coated on a current collector formed of a thin-film metal foil, and an uncoated region in which the active material is not coated.

A negative electrode uncoated region 11 a is formed at a side end of the other side of the negative electrode 11 along a length direction of the negative electrode 11, and a positive electrode uncoated region 12a is formed at a side end of one side of the positive electrode 12 along a length direction of the positive electrode 12. In addition, the negative electrode 11 and the positive electrode 12 are spiral-wound after inserting the separator 13 that is an insulator therebetween.

However, the present invention is not limited thereto, and the electrode assembly 10 may have other structures, for example, wherein the positive electrode and the negative electrode including a plurality of sheets are laminated with an insulator located therebetween.

The case 26 is formed as an approximate cuboid, and an opening is formed on a side thereof. The cap assembly 30 includes a cap plate 31 covering the opening of the case 26, a first terminal 21 on the cap plate 31 and electrically connected to the negative electrode 11, a second terminal 22 on the cap plate 31 and electrically connected to the positive electrode 12, and a vent member 39 having a notch 39a formed to be fractured according to a predetermined internal pressure. The vent member 39 is installed in a vent hole 34 formed at the cap plate 31.

The cap plate 31 is formed of a thin metal plate, and a sealing cap 38 sealing an electrolyte injection opening 37 formed at one side thereof is fixed and installed at the cap plate 31. A short-circuit hole 32 is formed at the cap plate 31, and a short-circuit member 35 is installed at the short-circuit hole 32. The short-circuit member 35 is formed in the shape of a circular plate, and includes a supporting part 35a and a connector 35b positioned inside the supporting part 35a. The supporting part 35a is formed in a ring shape and is supported by a step protruding inside the short-circuit hole 32 to be fixed on the upper surface of the cap plate 31 by welding. The connector 35b is curved downward toward the case and electrolyte assembly to have a cross-section of an arc shape that convexly protrudes generally in a direction toward the electrode assembly 10. When the internal pressure of the case 26 is increased, the short-circuit member 35 is transformed to protrude in substantially the opposite direction and to contact the first terminal 21 thereby generating the short.

The first terminal 21 and the second terminal 22 are installed to penetrate terminal holes H1 and H2 formed at the cap plate 31, and are electrically connected to the electrode assembly 10. That is, the first terminal 21 is installed to be electrically connected to the negative electrode 11, and in this case, the first terminal 21 is electrically connected to the negative electrode 11 through a current collecting member 25. A sealing member 40 enclosing the first terminal 21 is installed at the first terminal 21.

The second terminal 22 is installed to be electrically connected to the positive electrode 12, and in this case, the second terminal 22 is electrically connected to the positive electrode 12 through a current collecting member 27. A sealing member 50 enclosing a portion of the second terminal 22 is installed at the second terminal 22.

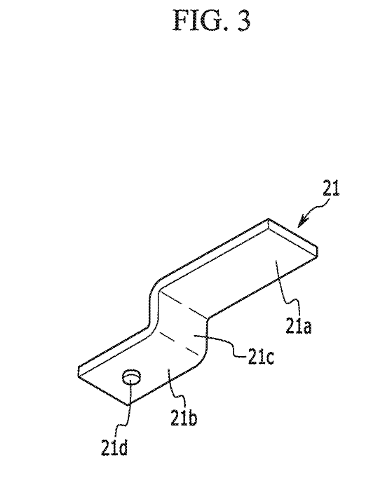

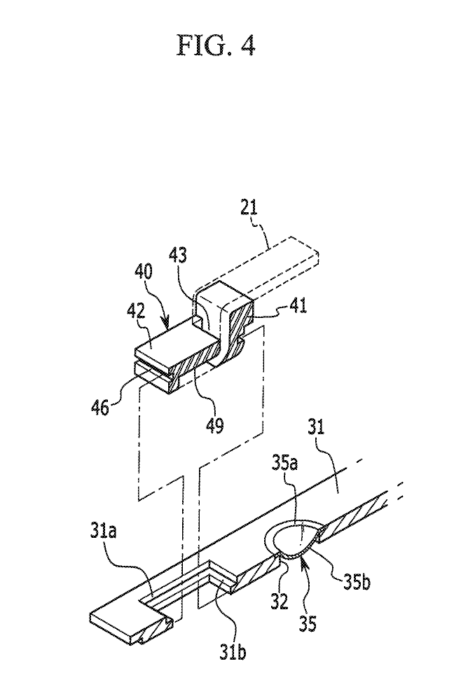

FIG. 3 is a perspective view of the first terminal 21 according to the first exemplary embodiment of the present invention, and FIG. 4 is an exploded perspective view of the cap plate 31 and the sealing member 21 according to the first exemplary embodiment of the present invention.

Referring to FIG. 3 and FIG. 4, the second terminal 22 and members connected thereto are symmetrical with the first terminal 21 and members connected thereto such that the description of the first terminal 21 and the members connected thereto equates to the description of the second terminal 22.

The first terminal 21 is formed of a plate shape and includes an upper connection part 21a positioned on the cap plate 31, a current collecting connection part 21b inserted inside the case 26 and coupled to the current collecting member 25, and a middle connection part 21c formed between the upper connection part 21a and the current collecting connection part 21b and bent at the upper connection part 21a and the current collecting connection part 21b.

The upper connection part 21a is oriented substantially parallel to the cap plate 31 on the cap plate 31, and is separated from the short-circuit member 35 to be positioned on the short-circuit member 35.

The current collecting connection part 21b is oriented substantially parallel to the cap plate 31 under the cap plate 31, and a protrusion 21d inserted into the current collecting member 25 to be coupled to the current collecting member 25 by welding is formed at the bottom surface of the current collecting connection part 21b.

The middle connection part 21c is curved substantially at a right angle at the upper connection part 21a and the current collecting connection part 21b to connect the upper connection part 21a and the current collecting connection part 21b and is inserted into a hole 43 formed at the sealing member 40. Also, the middle connection part 21c penetrates the cap plate 31 to connect the upper connection part 21a located outside of the case 26 and the current collecting connection part 21b located inside the case 26.

The upper connection part 21a and the current collecting connection part 21b are oriented substantially parallel to the cap plate 31, and the middle connection part 21c is oriented substantially perpendicular to the upper connection part 21a and the current collecting connection part 21b.

The sealing member 40 includes an upper sealing part 41 mounted on the cap plate 31 and a lower sealing part 42 inserted into and fixed to the terminal hole H1 formed at the cap plate 31. The upper sealing part 41 contacts the side surface of the middle connection part 21c and the bottom surface of the upper connection part 21a such that the upper connection part 21a is supported to be separated from the cap plate.

The lower sealing part 42 includes the hole 43 in which the middle connection part 21c is inserted, and a mounting groove 49 connected to the hole 43 and inserted with the current collecting connection part 21b is formed at the bottom surface. The hole 43 is formed to penetrate the cap plate.

Also, a sealing groove 46 receiving a protrusion 31b protruding to the inside from the terminal hole H1 is formed at the circumference of the lower sealing part 42. The protrusion 31b is extended according to the circumference direction at the interior circumference of the terminal hole H1, and the sealing groove 46 is extended according to the circumference of the lower sealing part 42 to receive the protrusion 31b. Also, a supporting groove 31a mounted with the side upper end of the lower sealing part is formed on the protrusion 31b. Accordingly, the sealing member 40 may be stably fixed to the cap plate 31.

When the first terminal 21 is installed on the cap plate 31, the sealing member 40 is formed by an insert molding method. Accordingly, the sealing member 40 is formed and simultaneously is fixed and installed to the cap plate 31, thereby being fixed on the cap plate 31 while enclosing the first terminal 21.

Like the first terminal 21, the second terminal 22 includes an upper connection part positioned on the cap plate 31, a current collecting connection part inserted inside the case 26 and coupled to the current collecting member 27, and a middle connection part formed between the upper connection part and the current collecting connection part and bent at the upper connection part and the current collecting connection part. Also, the sealing member 50 inserted into the terminal hole H2 and supporting the second terminal 22 is installed at the second terminal 22. The sealing member 50 is formed through an insert molding when the second terminal is installed at the cap plate.

A connection member 28 electrically connecting the second terminal 22 to the cap plate 31 is installed between the upper surface of the cap plate 31 and the second terminal 22. The connection member 28 is made of a metal such as copper, and is fixed to the second terminal 22 and the cap plate 31 by welding. Accordingly, the cap plate 31 and the case 26 are connected to the positive electrode.

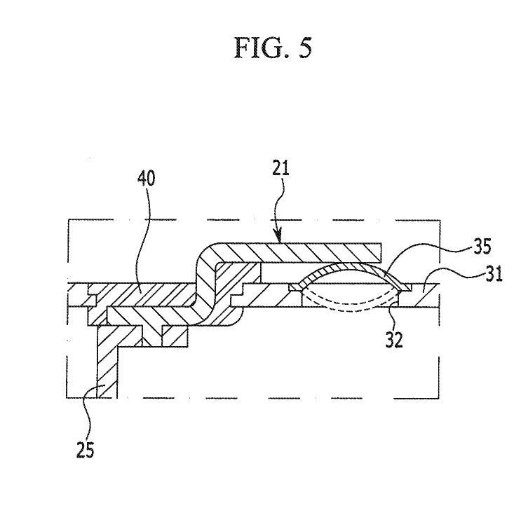

As shown in FIG. 5, if the internal pressure of the rechargeable battery 101 is increased, the short-circuit member 35 is deformed to be convex upward, i.e., extending substantially away from the electrode assembly 10. Accordingly, the bottom surface of the first terminal 21 and the upper surface of the short-circuit member 35 electrically contact each other such that the first terminal 21 connected to the negative electrode and the short-circuit member 35 connected to the positive electrode are shorted. Like the present exemplary embodiment, if the short is generated when the pressure is increased, the charges that are cumulated inside are instantaneously discharged such that the chance of explosion may be reduced.

Further, the short-circuit member 35 directly contacts the first terminal 21 such that the short may be easily generated even though a tab for the short-circuit is not installed or present. Also, the sealing members 40 and 50 are installed to the first terminal 21 and the second terminal 22, respectively, by an insert molding method such that the first terminal 21 and the second terminal 22 are easily installed.

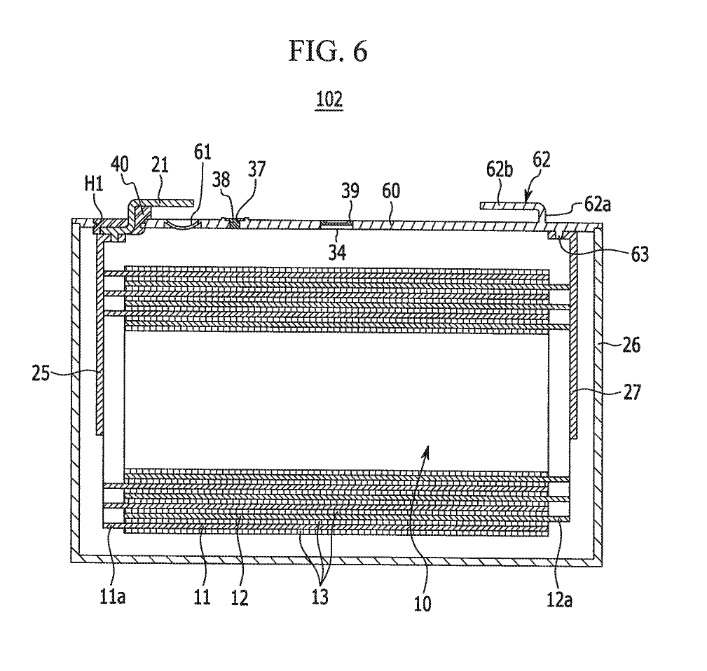

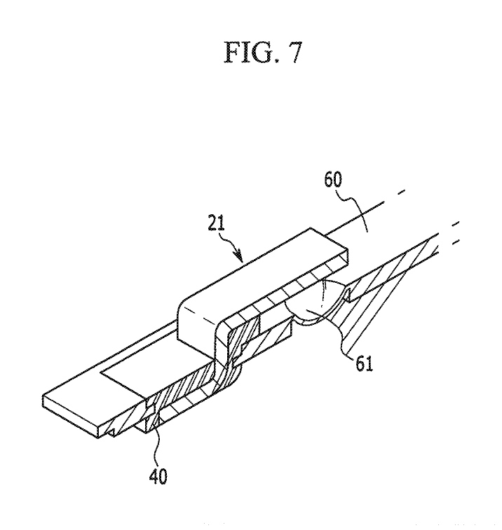

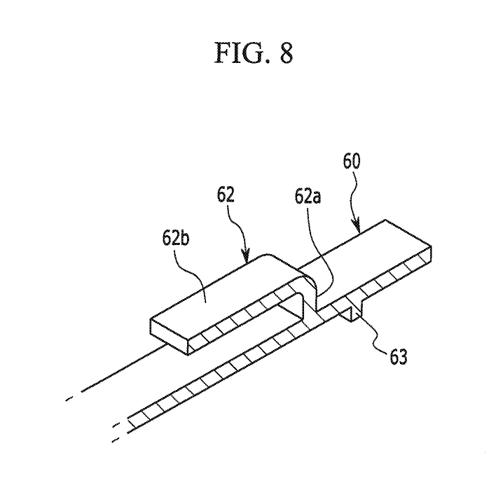

FIG. 6 is a cross-sectional view of a rechargeable battery according to the second exemplary embodiment of the present invention, FIG. 7 is a cut-away perspective view of a terminal and a cap plate according to the second exemplary embodiment of the present invention, and FIG. 8 is a cut-away perspective view of a terminal and a cap plate according to the second exemplary embodiment of the present invention.

Referring to FIG. 6 to FIG. 8, the rechargeable battery according to the present exemplary embodiment is the same as the rechargeable battery according to the first exemplary embodiment except for the cap plate and the second terminal such that the overlapping description is omitted.

The first terminal 21 electrically connected to the negative electrode 11 is fixed and installed at a cap plate 60 through the sealing member 40, and the second terminal 62 electrically connected to the positive electrode 12 is formed at the cap plate 60. The first terminal 21 is positioned on a short-circuit member 61 formed at the cap plate 60 and is oriented to be separated from the short-circuit member. The short-circuit member 61 is integrally formed with the cap plate 60 such that the short-circuit member 61 is thinner than a remainder of the cap plate 60 and is made of a structure that is curved to be convex downward, i.e., the short circuit member extends generally towards the electrode assembly 10. Like the present exemplary embodiment, the short-circuit member 61 is integrally formed with the cap plate 60, so it is not necessary to additionally form the short-circuit member 61, thereby simplifying an assembly process.

The second terminal 62 includes a middle connection part 62a protruding from the upper surface of the cap plate 60 and extending upward, and an upper connection part 62b bent from the middle connection part 62a. The second terminal 62 is formed with the plate shape that is integrally formed with the cap plate 60, and the middle connection part 62a protrudes perpendicular to the upper surface of the cap plate 60. The upper connection part 62b is bent from the middle connection part 62a to be oriented substantially parallel to the upper surface of the cap plate 60 at the upper surface of the cap plate 60.

Additionally, the current collecting member 27 electrically connected to the positive electrode 12 is adhered to the cap plate 60 by welding. A protrusion 63 close to the current collecting member 27 is formed at the lower surface of the cap plate 60, and the current collecting member 27 is fixed to the cap plate 60 by welding such that the current collecting member 27 is inserted over the protrusion 63 which protrudes into the current collecting member. Accordingly, the cap plate 60 is electrically connected to the positive electrode 12 and the second terminal 62 is electrically connected to the positive electrode 12 through the cap plate 60.

As described above, according to the present exemplary embodiment, the second terminal 62 is integrally formed with the cap plate 60 such that it is not necessary to seal between the second terminal 62 and the cap plate 60 and the contact resistance between the second terminal 62 and the cap plate 60 may be reduced.

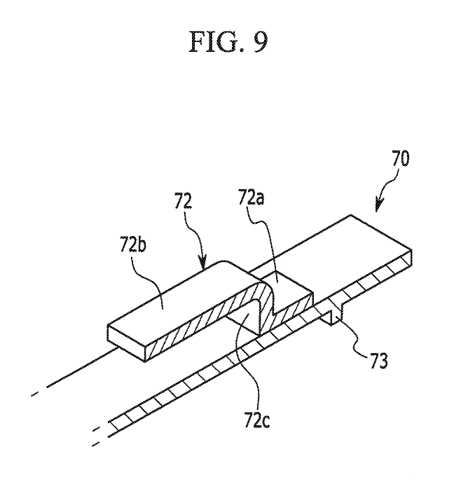

FIG. 9 is a cut-away perspective view of a terminal and a cap plate according to the third exemplary embodiment of the present invention.

Referring to FIG. 9, the rechargeable battery according to the present exemplary embodiment is the same as the rechargeable battery according to the second exemplary embodiment except for the second terminal such that the overlapping description is omitted.

In one embodiment, the second terminal 72 electrically connected to the positive electrode 12 is formed at a cap plate 70. The second terminal 72 includes a lower connection part 72a fixed to the upper surface of the cap plate 70 by welding, a middle connection part 72c bent from the lower connection part and protruding upward, and an upper connection part 72b bent from the middle connection part 72c. The lower connection part 72a is oriented substantially parallel to the cap plate 70 and is fixed to the upper surface of the cap plate 70 by welding. The middle connection part 72c is bent perpendicular from the lower connection part 72a to protrude upward. The upper connection part 72b is bent perpendicular from the middle connection part 72c to be oriented substantially parallel to the upper surface of the cap plate 70.

A protrusion 73 electrically connected to the positive electrode 12 and coupled to the current collecting member 27 is formed at the lower surface of the cap plate 70. Accordingly, the cap plate 70 is electrically connected to the positive electrode 12, and the second terminal 72 is electrically connected to the positive electrode 12 through the cap plate 70.

As described above, according to the present exemplary embodiment, the second terminal 72 is fixed to the upper surface of the cap plate 70 by welding such that the cap plate 70 does not need the hole in which the second terminal 72 is inserted, and thereby it is not necessary to seal between the second terminal 72 and the cap plate 70.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

### DESCRIPTION OF SYMBOLS

| | |
|---|---|
| 101, 102: rechargeable battery | 10: electrode assembly |
| 11: negative electrode | 11a: negative uncoated region |

| | |
|---|---|
| 12: positive electrode | 12a: positive electrode uncoated region |

| | |
|---|---|
| 13: separator | 21: first terminal |

| | |
|---|---|
| 21a: upper connection part | 21b: current collecting connection part |
| 21c: middle connection part | 21d: protrusion |
| 22, 62, 72: second terminal | 25, 27: current collecting member |

| | |
|---|---|
| 26: case | 28: connection member |
| 30: cap assembly | 31, 60, 70: cap plate |

| | |
|---|---|
| 31a: supporting groove | 31b: protrusion |

| | |
|---|---|
| 35, 61: short-circuit member | 35a: supporting part |

| | |
|---|---|
| 35b: connector | 40, 50: sealing member |
| 41: upper sealing part | 42: lower sealing part |

| | |
|---|---|
| 43: hole | 46: sealing groove |

49: mounting groove

What is claimed is:

1. A rechargeable battery comprising:
an electrode assembly comprising a positive electrode and a negative electrode;
a case accommodating the electrode assembly;
a cap plate coupled to the case;
a first terminal and a second terminal electrically connected to the electrode assembly and protruding from the cap plate; and
a short-circuit member at the cap plate and configured to contact the first terminal to induce a short circuit.

2. The rechargeable battery of claim 1, wherein the first terminal comprises an upper connection part spaced from the short-circuit member and positioned over the short-circuit member,
a current collecting connection part connected to the electrode assembly, and
a middle connection part located between the upper connection part and the current collecting connection part and bent at an angle from the upper connection part and the current collecting connection part.

3. The rechargeable battery of claim 2, wherein the upper connection part and the current collecting connection part are oriented substantially parallel to the cap plate.

4. The rechargeable battery of claim 2, further comprising a sealing member between the first terminal and the cap plate that contacts the first terminal.

5. The rechargeable battery of claim 4, wherein the sealing member is formed by insert injection.

6. The rechargeable battery of claim 4, wherein the sealing member includes an upper sealing part mounted on the cap plate and a lower sealing part inserted and fixed to a terminal hole defined by the cap plate.

7. The rechargeable battery of claim 6, wherein the lower sealing part includes a hole in which the middle connection part is inserted.

8. The rechargeable battery of claim 7, wherein a groove connected to the hole and receiving a current collecting connection part is formed at a surface of the lower sealing part.

9. The rechargeable battery of claim 6, wherein a protrusion extends into the terminal hole, and a sealing groove receiving the protrusion is formed at the circumference of the lower sealing part.

10. The rechargeable battery of claim 9, wherein the protrusion extends circumferentially from an interior of the terminal hole, and the sealing groove extends circumferentially from the lower sealing part.

11. The rechargeable battery of claim 2, wherein the current collecting connection part is connected to the electrode assembly through a current collecting member, and a protrusion inserted into the current collecting member is formed at the lower surface of the current collecting connection part.

12. The rechargeable battery of claim 2, wherein the short-circuit member includes a supporting part spaced from the upper connection part, installed to face the lower surface of the upper connection part, and fixed to the cap plate, and a connector positioned inside the supporting part and curved downward to convexly protrude generally towards the electrode assembly.

13. The rechargeable battery of claim 1, wherein the short-circuit member is integrally formed with the cap plate and is thinner than a remainder of the cap plate, and is convexly curved downward generally towards the electrode assembly.

14. The rechargeable battery of claim 1, wherein a connection member electrically connecting the second terminal to the cap plate is formed between the second terminal and the cap plate.

15. The rechargeable battery of claim 1, wherein the current collecting member is coupled to the electrode assembly by welding, and the cap plate includes a protrusion inserted into the current collecting member.

16. The rechargeable battery of claim 15, wherein the second terminal includes a middle connection part integrally formed with the cap plate and protruding at the upper surface of the cap plate, and an upper connection part bent from the middle connection part.

17. The rechargeable battery of claim 15, wherein the second terminal includes a lower connection part fixed to the upper surface of the cap plate by welding, a middle connection part bent from the lower connection part to protrude upward, and an upper connection part bent from the middle connection part and oriented substantially parallel to the cap plate.
